(19) United States
(12) Patent Application Publication
(10) Pub. No.: US 2018/0371119 A1
(43) Pub. Date: Dec. 27, 2018

(54) PROCESS FOR PROVIDING INORGANIC POLYMER CERAMIC-LIKE MATERIALS

(71) Applicants: VINCE Reed, Ann Arbor, MI (US); Ahmad Madkour, EG (EG); Julien Marchal, FR (FR); Reed Shick, Midland, MI (US)

(72) Inventors: VINCE Reed, Ann Arbor, MI (US); Ahmad Madkour, EG (EG); Julien Marchal, FR (FR); Reed Shick, Midland, MI (US)

(21) Appl. No.: 15/342,624

(22) Filed: Nov. 3, 2016

Related U.S. Application Data
(60) Provisional application No. 62/251,923, filed on Nov. 6, 2015.

(51) Int. Cl. C08F 8/42

(52) U.S. Cl. CPC C08F 8/42; C08F 2810/00

(57) ABSTRACT

A process for providing inorganic polymer ceramic-like materials. The process comprises providing a first material which comprises at least one non-oxide ceramic powder, and, at least one metal oxide, and providing a second material which comprises a caustic slurry composed of alkaline water and a solvent, and, combining the materials with stirring. There is also provided a composition of matter provided by the above-mentioned process which is a chemically bonded ceramic polymer comprising metal oxide and non-oxide ceramic bonds.

### BACKGROUND OF THE INVENTION

Sodium Silicate bonded non oxide ceramic powders have been known for over 100 years. Abrasive materials bonded by sodium silicate and then heat set have been cast as hard, tough, strong grinding wheels (U.S. Pat. No. 1,555,119).

Coatings with SiC, BC, and TiC have been bonded with inorganic polymers including sodium silicate, SiOx, BrOx, phosphoric pentoxide (EP 1,340,735). Inorganic ceramic powders bonded by sodium silicate between temperatures of 50 and 1400 C° as coatings are known as well (U.S. Pat. No. 3,404,031).

Sodium Silicate reacted with “filler” such as metakaolin to bond ceramic powder is known (U.S. Pat. No. 8,480,801). This solidified ceramic body is fabricated by binding ceramic powder by means of water glass which serves as the binder. In fabricating this solidified ceramic body, the water glass is mixed with filler such as metakaolin, and metal ions in the filler dissolve and react with the water glass. Thus, sodium silicate constituting the water glass gets cross-linked to become an inorganic polymer. Then, a dehydration-condensation reaction proceeds along with water evaporation which results in the solidified ceramic body.

U.S. Pat. No. 7,097,679 teaches an abrasive material comprising at least one abrasive grain selected from the group consisting of aluminum oxide, silicon carbide, cubic boron nitride and diamond. The abrasive grain has a coating of an inorganic or organic binder and an abrasive filling material comprising a mixture of lithium carbonate and manganese sulfate.

U.S. Pat. No. 7,094,285 teaches an inorganic polymer matrix composition, binder composition, or foam composition, comprising: the reaction product of an alkali silicate, one or more non-silicate oxoanionic compounds or a reactive acidic glass, or combinations thereof; water; and a reinforcing media comprising fibers, fabrics, or microspheres, or combinations thereof; and optionally one or more additives; and optionally one or more network modifiers.

U.S. Pat. No. 6,969,422 teaches an inorganic matrix composition comprising the reaction product of an alkali silicate and/or alkali silicate precursors derived from alkali hydroxides or oxides and a silica source, a reactive glass, water, and optionally a clay and/or oxide filler.

The alkali silicates utilized can include a wide range of silica/alkali oxide (SiO₂/A₂O) ratios and percent solids levels. Such solutions can be purchased from commercial sources or prepared immediately prior to use from precursors such as a silica source and an alkali hydroxide, alkali oxide or carbonate or combination thereof. The alkali silicate can be derived from an alkali base, such as potassium hydroxide or sodium hydroxide, from potash or soda ash and a silica source.

Other composite materials include metal matrix composites (MMC), ceramic matrix composites (CMC), carbon-carbon composites as well as other inorganic matrix composites. A composite matrix may be 100% inorganic, or it may contain some organic content. Inorganic matrix networks include ceramics, silicates, glasses, aluminum silicates, alkali aluminum silicates, potassium silicates, sodium silicates, silicon carbides, silicon nitrides, alumina, cementitious materials, metals, metal alloys or other matrix materials known to those skilled in the art.

The matrix compositions may incorporate a wide variety of organic and inorganic fillers commonly used by those skilled in the art. The matrix may incorporate filler materials such as ceramic powders, mineral powders, silicon carbides, silicon nitrides, carbon, carbon black, molybdenum and its compounds, silicates, aluminum silicates, sodium aluminum silicates, potassium aluminum silicates or other inorganic fillers.

### The Invention

Thus, there is disclosed and claimed herein a process for providing inorganic polymer ceramic-like materials. The process comprises providing a first material which comprises at least one non-oxide ceramic powder, and, at least one metal oxide, and providing a second material which comprises a caustic slurry composed of alkaline water and a solvent, and, combining the materials with stirring.

In another embodiment, there is a composition of matter provided by the above-mentioned process which is a chemically bonded ceramic polymer comprising metal oxide and non-oxide ceramic bonds.

The ceramic is chemically cured below 150 C° with little to no shrinkage. Chemically bonded ceramics of metal oxides, such as geopolymers are known. Chemically bonded non-oxide ceramics such as magnesium phosphate are known. Metal oxide polymers filled with non-reactive non-oxide ceramics are also known. However mixed systems of polymers with bonded oxides and non-oxides in the same polymer backbone are novel.

### BRIEF DESCRIPTION OF THE DRAWINGS

FIG. 1 is a flow diagram showing flexural strength data for non-oxide additive, compared to identical 2 batches of formulations without the additive cured at 87° C. (std1, std2) and 107° C. (std1 high temp, std2 high temp).

### DETAILED DESCRIPTION OF THE INVENTION

There has been discovered a family of advanced inorganic/organic hybrid composite polymer ceramic containing mixed oxide and non-oxide metal bonds. These polymer materials can be euphonically described as thermoset ceramics. The material combines strength, hardness and high temperature performance of technical ceramics with the strength, ductility, thermal shock resistance, density, and easy processing of a polymer. The unique chemical structure of the polymer materials provide tailored strength properties, hardness, toughness and wear properties.

There has also been discovered a class of materials and methods to coat parts to form a controlled porosity, thermal conduction, emissivity, surface hardness, flexibility, toughness, elongation, electrical conduction, density, electromagnetic properties.

Due to the highly tailorable nature of the ceramic materials' properties, its compatibility with functional additives, ease of fabrication, and high strength-to-weight ratio, there are many applications to which it can be applied. Chemically bonded ceramic formulations can be customized to provide system components that are not only application-tailored in their shape, but in their physiochemical properties as well. In addition to the ceramics versatility in terms of manufacturing parts and components from the material itself, the material also has several applications for use in the coating industry. The chemical inertness and temperature resistance of the material to 3400° f. allows it to be used to coat both nonferrous and ferrous metals and metal alloys. Due to its high dimensional stability at high temperatures and low reactivity, the material can allow a disruptive innovation in allowing steel to be made non-corroding, low friction, low electrical and heat conducting. The tailorable thermal conductivity of the material is of especially great interest

The Chemically boded ceramic has several readily apparent dimensions of appeal: Its composition can be composed of available refined feed stocks, and can optionally include various quantities of USA-sourced technical grade postindustrial waste stream materials, offsetting both bulk material costs and decreasing environmental impact of formulation.

It contains no formaldehyde, VOC's, or heavy metals, thus mitigating personnel safety risk.

It is potentially amenable to 3D-printing-based rapid prototyping and fabrication methodologies; applications include rapid production of both part and molds
When used as a mold, the HCPC material can be tooled quickly in gel state, thereby minimizing machine time and labor expenses.

If used as a mold, its high temperature stability and thermal conductivity allows for fast demold times of both cast metals, and sequentially, thermoset/plastics.

The same mold can be used to cast multiple material types, including Li—Al alloys, Steel, and as well as organic polymers.

A new method for producing a new class of inorganic polymer ceramic like materials is disclosed. The polymers are a mixture of metal oxide and non-oxide ceramics. The polymers are useful as a mold tooling, coatings, foams and a wide range of products with ceramic like properties. The polymer may be sprayed, cast, milled, printed or a combination thereof. Functionality can be modified with additives to modify toughness, strength, hardness, thermal conductivity, emissivity appearance etc. The polymer may be homogenous or heterogeneous with different hardness, toughness, strength, wear or conductive properties.

Resin requires at least Si—C—C. The instant invention has only one Si—C, or so it is theorized. The curable resin composition according to the present invention may further include an inorganic filler. The inorganic filler is exemplified by, but not limited to, nanosilica, nanotitania, nanozirconia, carbon nanotubes, silica, alumina, mica, synthetic mica, talc, calcium oxide, calcium carbonate, zirconium oxide, titanium oxide, barium titanate, kaolin, bentonite, diatomaceous earth, boron nitride, aluminum nitride, silicon carbide.

The present invention disclosed is unique from existing prior art in both its fundamental composition of matter, and perhaps more notable, its mechanism of synthesis. The reaction pathway by which the disclosed material is obtained proceeds through first the dissolution of the amorphous silicon, alumina, carbon, and alkali metal (LiOH), in an alkaline solution co-solvated with one or more polar aprotic or protic solvents. This solution hardens into a gel-state as a result silanol condensation complimented by of cationic stabilization of the free labile anionic network forming elements (Al, Si, O, C). The physical properties of this gel state, and the states immediately preceding it, are largely a function of the relative concentration of divalent cations: monovalent cations to network forming elements (Al, Si, O, C).

This gel is stable between several minutes to several months, after which it will undergo dehydration-mediated shrinkage and cracking. The gel state is then subjected to curing at elevated temperatures and humidity, consisting of various pH water and solvents, at various pressures. During this curing, the reactivity of the system increases as solvolysis of the gel system recuperates alkalinity of the system, re-dissolving the silanol condensation product to a greater or lesser extent, and mediating a complete amorphous structure formation of the network forming elements (Al, Si, O, C).

The added heat of the system overcomes the endothermic barrier preventing the network forming reactions from taking place previously. Al and Si are bound via bridging oxygen generated via hydrolysis, which consumes alkalinity of the gel, and C—Si, Si—C—Si and potentially metastable Al—C, bonds are formed. The fundamental monomer of the reaction may be any variation of O, Al, C, and Si, e.g. Al—O—Si—C—Si—O—Al—O. More monocationic species will lead to a more polymeric and generally weaker structure, whereas divalent cationic species, preferably Li, serve to create an even greater degree of crosslinking. Ca++ and Mg++ are less preferable due to their tendencies to rapidly form hydrates which often do not re-dissolve in the second phase of the reaction.

### EXAMPLES

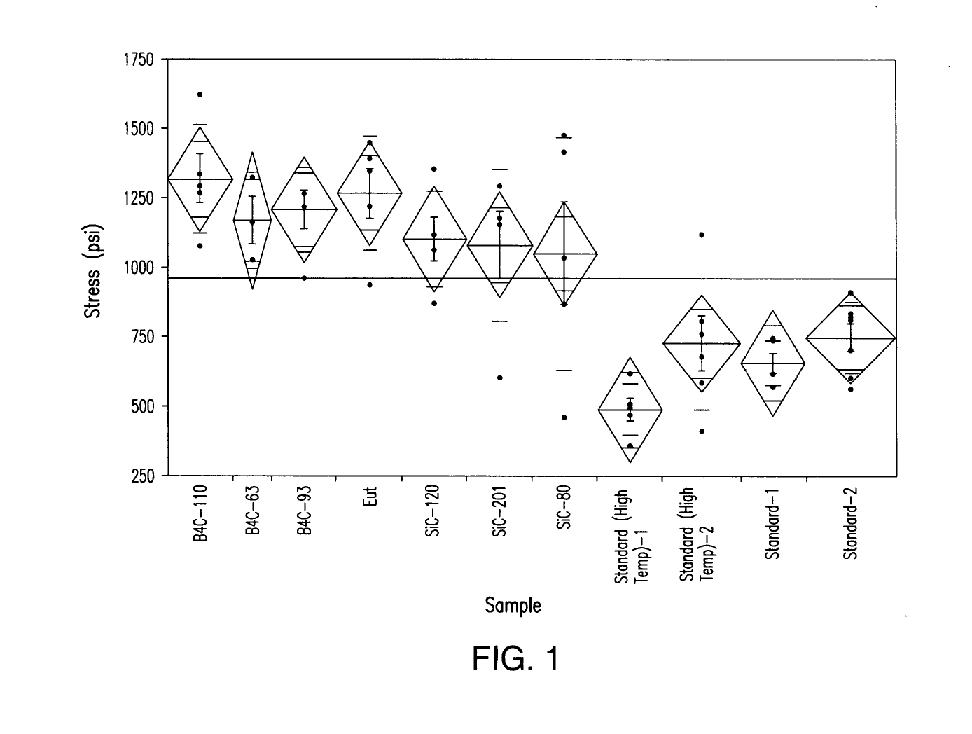

As shown in FIG. 1, the polymer material is processed as a reactive two-part material, similar to epoxy. During the fabrication process, the material as mixed can have a viscosity from 500 to 25,000 cPS. The lower viscosity is better for spraying thin films. The medium viscosity is best for casting parts in forms, while the higher viscosity is suitable as a extruded or prilled. The spray techniques may include air spraying, airless spraying, electro spraying, rotary cone spraying, and ultrasonic spraying.

The final cure reaction occurs when the ‘gel state’ part is exposed to temperatures of 160-250 F° for 2-6 hours. Longer curing times yield stronger materials. This cures the polymer to an advanced ceramic-like state. Shrinkage is in the range of less than 0.01%, allowing very fine tolerances. A molecularly-smooth surface allows for low cost high performance, rapid, complex parts manufacture with excellent surface texture. The texture may be smooth and high gloss or may be made matte as desired. The advanced hybrid is a suitable alternative for critical and strategic coatings.

### Example 1

A Solid Component comprising:

170 g Fly Ash

80 g Silicon Carbide

A Liquid Component comprising:

8.5 g Methanol

23.9 Sodium hydroxide

0.4 ethylene glycol

4.6 g borax

3.3 g 37% formalin

95.1 8 g 40% sodium silicate solution

4.2 g Water

The solid component was blended into the liquid component to make a fully mixed slurry. The slurry was poured into a form and allowed to form a hydrogel for two hours. The form was removed and the solid hydrogel placed in a polyethylene bag, sealed and cured for 12 hours at 80 C. The cured ceramic was removed from the bag.

### Example 2

### Example 2

Flexural strength data for Non-oxide additive, compared to identical 2 batches of formulations without the additive cured at 87° C. (std1, std2) and 107° C. (std1 high temp, std2 high temp). For the examples, the activator was blended with the dry components into a slurry and cast into a bar form. The slurry was cured for 24 hours at either 87° C. or 107° C. as indicated in each example. The flex data was generated using ASTM C 1341.

B4C-110: 135 g Activator, 175 g Fly ash, 2 g sodium poly-methyl methacrylate, 110 g boron carbide
B4C-63: 135 g Activator, 175 g Fly Ash, 2 g sodium poly-methyl methacrylate, 63 g boron carbide
B4C-93: 135 g Activator, 175 g Fly Ash, 2 g sodium poly-methyl methacrylate, 93 g boron carbide
Eut: 135 g Activator, 175 g Fly Ash), 2 g sodium poly-methyl methacrylate, 27 g SiC, 83 g boron carbide
SiC-120: 135 g Activator, 175 g Fly Ash, 2 g sodium poly-methyl methacrylate, 120 g boron carbide
SiC-201: 135 g Activator, 175 g Fly Ash, 2 g sodium poly-methyl methacrylate, 201 g boron carbide
SiC-80: 135 g Activator, 175 g Fly Ash, 2 g sodium poly-methyl methacrylate, 80 g boron carbide

### Std1 or 2: 135 g Activator, 175 g Fly Ash

Activator Solution

7 g Methanol

20 g potassium hydroxide

1.8 g ethylene glycol

3.6 g borax

3.4 g formalin

99.2 g 40% sodium silicate solution

1. (canceled)

2. A composition as claimed in claim 10 wherein the non-oxide ceramic is covalently bonded to the polymer backbone.

3. A process for providing inorganic polymer ceramic-like materials, said process comprising:
A. providing a first material which comprises at least one non-oxide ceramic powder, and, at least one metal oxide;
B. providing a second material which comprises a caustic slurry composed of alkaline water and a solvent;
C. combining A. and B. and stirring.

4. A process as claimed in claim 3 wherein, in addition, there is present a material to cause an internal exothermal reaction to cure the materials.

5. A product produced by the process of claim 4.

6. A process as claimed in claim 4 wherein the at least one non-oxide ceramic powder is selected from the group consisting essentially of SiC, SiN, TiN, BC, WC, and BN.

7. A process as claimed in claim 3 wherein the at least one metal oxide is selected from the group consisting of alumina oxide, silicon oxide, magnesium oxide, lithium oxide, and calcium oxide.

8. A process as claimed in claim 3 wherein the solvent is selected from the group consisting essentially of methanol, ethanol and reactive amorphous carbon.

9. The process as claimed in claim 3 wherein, in addition, there is present other materials selected from the group consisting of fillers, and fibers.

10. A composition of matter produced by combining:
a. a non-oxide ceramic,
b. a polymer selected from the group consisting of:
i. an amorphous polymer, and,
ii. a microcrystalline polymer.
